(19) United States
(12) Patent Application Publication
(10) Pub. No.: US 2017/0068945 A1
(43) Pub. Date: Mar. 9, 2017

(54) POS TERMINAL APPARATUS, POS SYSTEM, COMMODITY RECOGNITION METHOD, AND NON-TRANSITORY COMPUTER READABLE MEDIUM STORING PROGRAM

(71) Applicant: NEC CORPORATION, Minato-ku, Tokyo (JP)

(72) Inventors: Kazuki TSUCHIMOCHI, Tokyo (JP); Eiji MURAMATSU, Tokyo (JP); Michio NAGAI, Tokyo (JP); Shinichi ANAMI, Tokyo (JP); Jun KOBAYASHI, Tokyo (JP)

(73) Assignee: NEC Corporation, Minato-ku, Tokyo (JP)

(21) Appl. No.: 15/120,825

(22) PCT Filed: Nov. 5, 2014
(86) PCT No.: PCT/JP2014/005548

§ 371 Date: Aug. 23, 2016

(30) Foreign Application Priority Data
Mar. 20, 2014 (JP) 2014-058107

(51) Int. Cl. G06Q 20/20; G06K 9/00; H04N 7/18; G06K 9/62; G06T 7/20; G06K 9/78

(52) U.S. Cl. CPC G06Q 20/208; G06T 7/2093; G06K 9/78; H04N 7/181; G06K 9/6202; G06K 9/00335; G06T 2207/30241; G06T 2207/30196

(57) ABSTRACT

A POS terminal apparatus, a POS system, a commodity recognition method, and a non-transitory computer readable medium storing a program capable of efficiently performing the commodity recognition are provided. The POS terminal apparatus (1) includes a movement-trajectory detection unit (2), a settlement-customer identification unit (4), and a commodity recognition process unit (6). The movement-trajectory detection unit (2) detects movement trajectories of customers in a store by using images taken by at least one image-pickup apparatus. The settlement-customer identification unit (4) identifies a customer who is about to make a settlement for a commodity. The commodity recognition process unit (6) performs a process for recognizing the commodity for the settlement, in which commodities displayed at positions corresponding to the detected movement trajectory for the customer identified by the settlement-customer identification unit (4) are set as candidates.

### TECHNICAL FIELD

The present invention relates to a POS (Point Of Sales) terminal apparatus, a POS system, a commodity recognition method, and a non-transitory computer readable medium storing a program. In particular, the present invention relates to a POS system, a commodity recognition method, and a non-transitory computer readable medium storing a program for making a settlement (or payment) for a commodity.

### BACKGROUND ART

In POS (Point Of Sales) terminals installed in settlement places (checkout counters: cash registers) of convenience stores, supermarkets, mass merchandising stores, and the like, a salesclerk enters data of commodities with barcodes attached thereto by using a barcode input device and enters data of commodities to which barcodes cannot be attached by using a keyboard. Therefore, the time necessary for entering data of commodities with no barcodes attached thereto widely changes depending on the level of the skill of the salesclerk. In some cases, a salesclerk attaches store-original barcodes to commodities with no barcodes attached thereto in advance. However, such a task leads to an increase in working hours. Meanwhile, recently, use of self-checkout counters in which a customer operates a POS terminal apparatus (i.e., POS terminal device) by himself/herself has been increasing. Since it takes time for a customer to find where a barcode is attached to a commodity, the time necessary for operating the POS terminal apparatus further increases.

Therefore, a technique for taking an image (i.e., a picture) of a commodity by using a camera or the like embedded in a POS terminal apparatus and recognizing the commodity by using an image recognition technique has been proposed. In relation to the above-mentioned technique, Patent Literature 1 discloses an information-processing apparatus capable of simplifying and efficiently performing a determination of a commodity corresponding to an imaged object. The information-processing apparatus disclosed in Patent Literature 1 includes capturing means for capturing an image taken by image pickup means, and notification means for, when a degree of similarity between the image of an object taken by the image pickup means and a reference image of each commodity satisfies a condition for determining that the imaged object is one of the commodities corresponding to the reference images, performing a notification that it is determined that the imaged object is a commodity corresponding to the reference image for satisfying the condition.

### CITATION LIST

### Patent Literature

Japanese Unexamined Patent Application Publication No. 2013-89085

### SUMMARY OF INVENTION

### Technical Problem

There are an enormous number of commodities displayed in a store. Therefore, in a case where a commodity is recognized by using the image recognition technique, it may take an enormous amount of time for the recognition process of the commodity to be performed when the commodity for the settlement is compared with all of the commodities in the store. Further, when the commodity for the settlement is compared with all of the commodities in the store, because commodities similar to the commodity for the settlement may be displayed in the store, an erroneous recognition of a similar commodity may occur. The information-processing apparatus disclosed in the above-mentioned Patent Literature 1 calculates the degree of similarity between reference images of all commodities displayed in the store and the image of an object taken by the image pickup means. Therefore, the processing time becomes enormous. Further, because the reference images of all commodities displayed in the store are to be processed objects, an erroneous recognition of a similar commodity may occur. Thus, it is impossible to efficiently perform the commodity recognition.

The present invention has been made to solve the above-described problem and provide a POS terminal apparatus, a POS system, a commodity recognition method, and a non-transitory computer readable medium storing a program capable of efficiently performing the commodity recognition.

### Solution to Problem

A POS terminal apparatus according to the present invention includes: movement trajectory detection means for detecting movement trajectories of customers in a store by using images taken by at least one image-pickup means; customer identification means for identifying the customer who is about to make a settlement for a commodity; and recognition process means for performing a process for recognizing the commodity for the settlement, in which commodities displayed at positions corresponding to the detected movement trajectory for the identified customer are set as candidates.

Further, a POS system according to the present invention includes: at least one image-pickup means; movement trajectory detection means for detecting movement trajectories of customers in a store by using images taken by the image-pickup means; customer identification means for identifying the customer who is about to make a settlement for a commodity; and recognition process means for performing a process for recognizing the commodity for the settlement, in which commodities displayed at positions corresponding to the detected movement trajectory for the identified customer are set as candidates.

Further, a commodity recognition method according to the present invention includes: detecting movement trajectories of customers in a store by using images taken by at least one image-pickup means; identifying the customer who is about to make a settlement for a commodity; and performing a process for recognizing the commodity for the settlement, in which commodities displayed at positions corresponding to the detected movement trajectory for the identified customer are set as candidates.

Further, a program according to the present invention causes a computer to execute: a movement trajectory detection step of detecting movement trajectories of customers in a store by using images taken by at least one image-pickup means; a customer identification step of identifying the customer who is about to make a settlement for a commodity; and a recognition process step of performing a process for recognizing the commodity for the settlement, in which commodities displayed at positions corresponding to the detected movement trajectory for the identified customer are set as candidates.

### Advantageous Effects of Invention

According to the present invention, it is possible to provide a POS terminal apparatus, a POS system, a commodity recognition method, and a non-transitory computer readable medium storing a program capable of efficiently performing the commodity recognition.

### BRIEF DESCRIPTION OF DRAWINGS

FIG. 1 is shows an outline of a POS terminal apparatus according to an exemplary embodiment of the present invention;

FIG. 2 shows a POS system according to a first exemplary embodiment;

FIG. 3 shows an example of a store to which the POS system according to the first exemplary embodiment is applied;

FIG. 4 is a side view showing an external appearance of a POS terminal apparatus according to the first exemplary embodiment;

FIG. 5 shows a hardware configuration of the POS terminal apparatus according to the first exemplary embodiment;

FIG. 6 is a functional block diagram of the POS terminal apparatus according to the first exemplary embodiment;

FIG. 7 shows an example of the movement trajectory information stored in a movement-trajectory information storage unit;

FIG. 8 shows an example of the store shelf information stored in a store-shelf information storage unit;

FIG. 9 is a flowchart showing a process performed by the POS terminal apparatus according to the first exemplary embodiment;

FIG. 10 shows an example of a store to which a POS system according to a second exemplary embodiment is applied;

FIG. 11 is a functional block diagram of the POS terminal apparatus according to the second exemplary embodiment;

FIG. 12 is a flowchart showing a movement-trajectory detection process according to the second exemplary embodiment;

FIG. 13 is a flowchart showing a commodity recognition process according to the second exemplary embodiment;

FIG. 14 shows an example of a store to which a POS system according to a third exemplary embodiment is applied;

FIG. 15 is a functional block diagram of the POS terminal apparatus according to the third exemplary embodiment;

FIG. 16 is a flowchart showing a movement-trajectory detection process according to the third exemplary embodiment; and

FIG. 17 is a flowchart showing a commodity recognition process according to the third exemplary embodiment.

### DESCRIPTION OF EMBODIMENTS

### Outline of Exemplary Embodiment According to the Present Invention

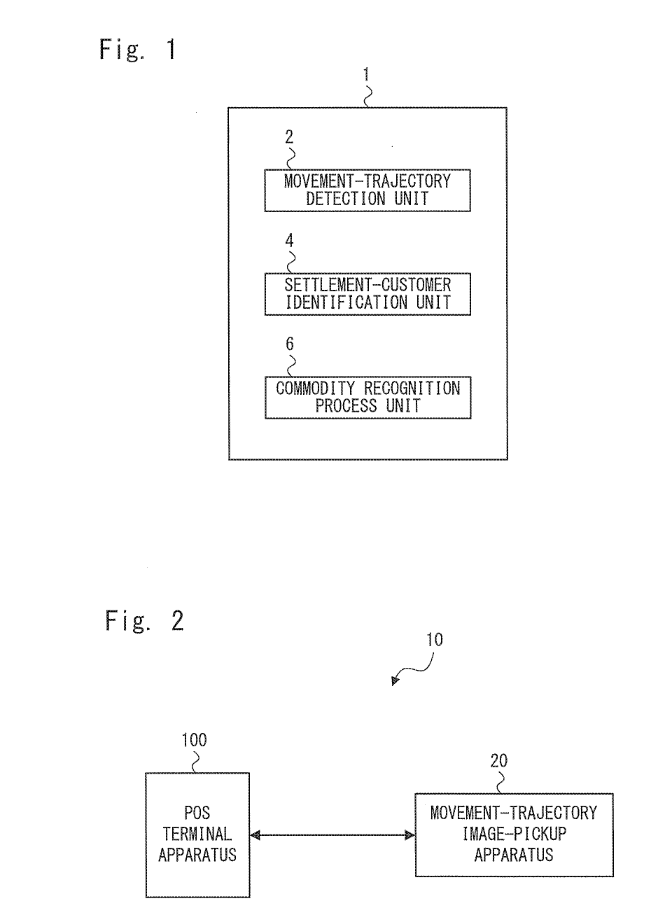

Prior to giving an explanation of exemplary embodiments according to the present invention, an outline of an exemplary embodiment thereof is explained. FIG. 1 shows an outline of a POS terminal apparatus 1 according to an exemplary embodiment of the present invention. As shown in FIG. 1, the POS terminal apparatus 1 includes a movement-trajectory detection unit 2 (movement trajectory detection means), a settlement-customer identification unit 4 (customer identification means), and a commodity recognition process unit 6 (recognition process means).

The movement-trajectory detection unit 2 detects movement trajectories of customers in a store by using images taken by at least one image-pickup apparatus (image-pickup means). The settlement-customer identification unit 4 identifies a customer who is about to make a settlement (i.e., pay) for a commodity. The commodity recognition process unit 6 performs a process for recognizing the commodity for the settlement, in which commodities displayed at positions corresponding to the detected movement trajectory for the customer identified by the settlement-customer identification unit 4 are set as candidates. With the above-described configuration, the POS terminal apparatus 1 according to an exemplary embodiment of the present invention can efficiently perform the commodity recognition. Note that, according to the POS system including the above-described POS terminal apparatus 1, a commodity recognition method and program for performing the above-described process, it is also possible to efficiently perform the commodity recognition.

### First Exemplary Embodiment

Exemplary embodiments according to the present invention are explained hereinafter with reference to the drawings.

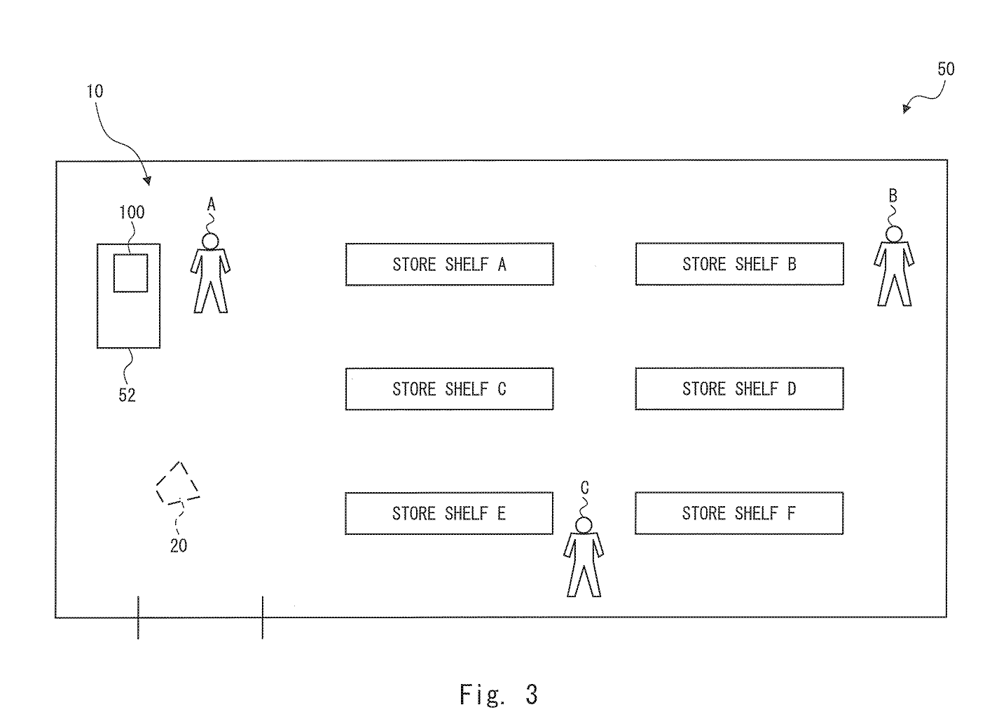

FIG. 2 shows a POS system 10 according to a first exemplary embodiment. FIG. 3 shows an example of a store 50 to which the POS system 10 according to the first exemplary embodiment is applied.

The POS system 10 includes a POS terminal apparatus 100 and at least one movement-trajectory image-pickup apparatus 20 (i.e., image-pickup apparatus for a movement trajectory). The POS terminal apparatus 100 and the movement-trajectory image-pickup apparatus 20 are connected to each other so that communication can be performed therebetween. The communication between them may be wire communication or wireless communication and various communication standards can be applied to the communication. The POS terminal apparatus 100 and the movement-trajectory image-pickup apparatus 20 may be connected to each other via a network (for example, wireless LAN (Local Area Network), internet or the like). The POS terminal apparatus 100 and the movement-trajectory image-pickup apparatus 20 may communicate with each other by near field communication such as an infrared communication or Bluetooth (registered trademark).

As shown in FIG. 3 as an example, store shelves A to F are installed in the store 50 and the commodities are displayed on each store shelf. For example, customers A to C are moving within the store 50. The POS terminal apparatus 100 is placed on a counter table 52 which is installed in the store 50. A customer (settlement customer), who is about to make a settlement for a commodity, and a salesclerk (not shown) face each other across the POS terminal apparatus 100. In the example shown in FIG. 3, customer A is the settlement customer.

The movement-trajectory image-pickup apparatus 20 is used to detect the movement trajectories of the customers A to C in the store 50. Accordingly, the POS terminal apparatus 100 detects the movement trajectories of the customers A to C. The movement-trajectory image-pickup apparatus 20 is, for example, an image pickup device (camera) such as a CCD (Charge-Coupled Device) and performs a process for reading (i.e., taking) an image (a still image or a moving image) in the store 50. Specifically, the movement-trajectory image-pickup apparatus 20 shoots (i.e., photographs (hereinafter simply expressed as “shoots”)) the inside of the store 50 and generates a color or monochrome image (“movement-trajectory image”, i.e., an image for movement trajectory) including an image of the inside of the store 50. Note that the term “image” also means “image data representing an image” to be processed in information processing hereinafter. The movement-trajectory image-pickup apparatus 20 is installed at any position in the store 50 and shoots the customers A to C. The movement-trajectory image-pickup apparatus 20 transmits, to the POS terminal apparatus 100, the movement-trajectory image which is obtained by shooting.

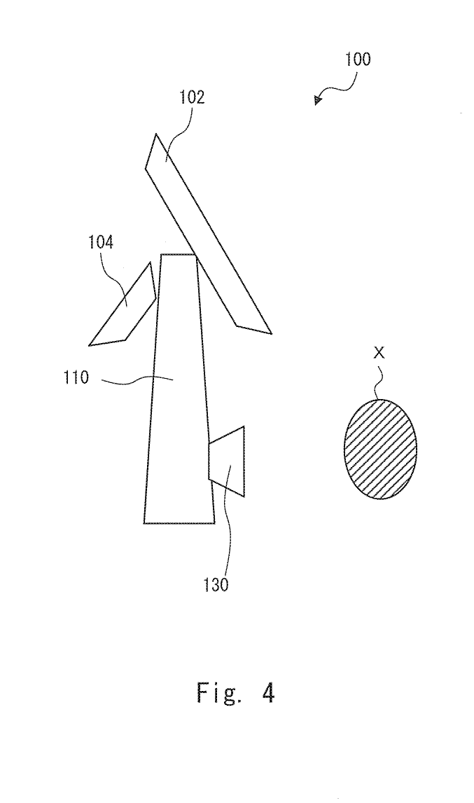

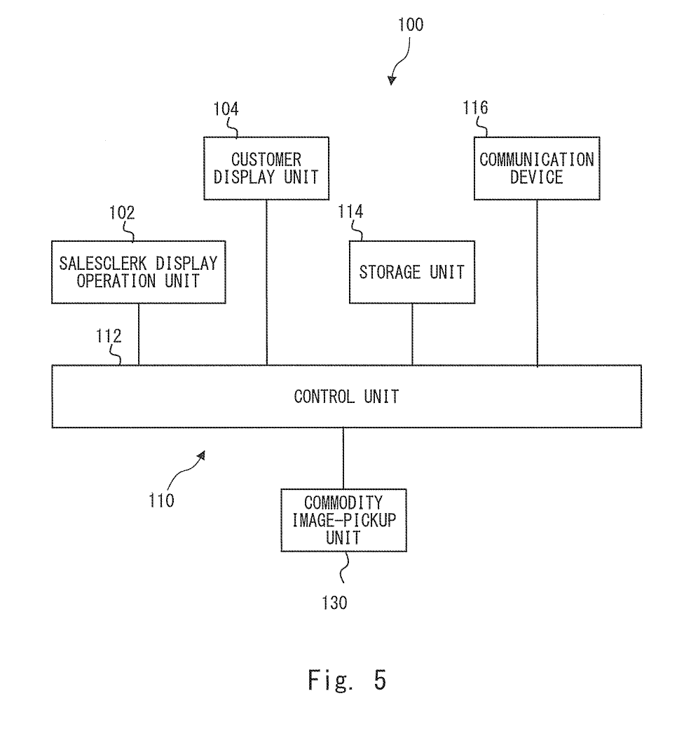

FIG. 4 is a side view showing an external appearance of a POS terminal apparatus 100 according to the first exemplary embodiment. Further, FIG. 5 shows a hardware configuration of the POS terminal apparatus 100 according to the first exemplary embodiment. The POS terminal apparatus 100 includes a salesclerk display operation unit 102, a customer display unit 104, an information processing apparatus 110, and a commodity image-pickup unit 130. As described above, the POS terminal apparatus 100 is placed on, for example, the counter table 52, and a customer and a salesclerk stand on the left and right sides, respectively, of the POS terminal apparatus 100 in FIG. 4, so as to face each other with the POS terminal apparatus 100 interposed therebetween.

The salesclerk display operation unit 102 is, for example, a touch panel, an LCD (Liquid Crystal Display), a keyboard, or the like. The salesclerk display operation unit 102 displays information necessary for the salesclerk under the control of the information processing apparatus 110 and receives an operation performed by the salesclerk.

The customer display unit 104 is, for example, a touch panel, an LCD, or the like. The customer display unit 104 displays information necessary for the customer under the control of the information processing apparatus 110. Further, the customer display unit 104 may include an input device and receive an operation performed by the customer as required.

The information processing apparatus 110 is, for example, a computer. The information processing apparatus 110 includes, for example, a control unit 112 such as a CPU (Central Processing Unit), a storage unit 114 such as a memory or a hard disk, and a communication device 116. The information processing apparatus 110 controls the operations of the salesclerk display operation unit 102, the customer display unit 104, and the commodity image-pickup unit 130. Further, the information processing apparatus 110 performs a necessary process according to an operation received by the salesclerk display operation unit 102. Further, the information processing apparatus 110 performs a necessary process such as an image process according to image information read by the commodity image-pickup unit 130. The communication device 116 performs a process necessary for performing communication with the movement-trajectory image-pickup apparatus 20 and a management device such as a server, which are connected to the communication device 116 through a network.

The commodity image-pickup unit 130 reads (i.e., takes) an image (settlement commodity image) of a commodity X for the settlement (settlement commodity), which is received from the settlement customer by the salesclerk. In this way, the POS terminal apparatus 100 performs a process for recognizing the settlement commodity X. Details of the recognition process are described later. The commodity image-pickup unit 130 is, for example, an image pickup device (camera) such as a CCD and performs a process for reading (i.e., taking) an image of the settlement commodity X. Specifically, the commodity image-pickup unit 130 shoots the settlement commodity X and generates an image (color or monochrome image) including an image of the settlement commodity X.

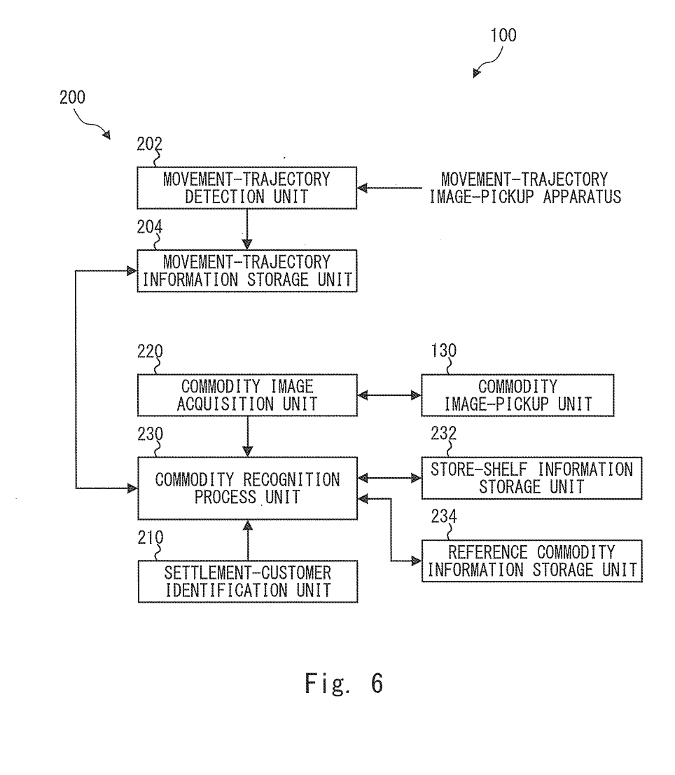

FIG. 6 is a functional block diagram of the POS terminal apparatus 100 according to the first exemplary embodiment. The POS terminal apparatus 100 according to the first exemplary embodiment includes a settlement process unit 200. The settlement process unit 200 includes a movement-trajectory detection unit 202, a movement-trajectory information storage unit 204, a settlement-customer identification unit 210, a commodity image acquisition unit 220, a commodity recognition process unit 230, a store-shelf information storage unit 232, and a reference commodity information storage unit 234.

Note that the settlement process unit 200 can be implemented by, for example, executing a program under the control of the control unit 112. More specifically, the settlement process unit 200 can be implemented by, for example, executing a program stored in the storage unit 114 under the control of the control unit 112. Further, each component in the settlement process unit 200 does not necessarily have to be implemented by software by using a program. That is, each component may be implemented by any combination of hardware, firmware, software, and the like. Further, each component in the settlement process unit 200 may be implemented by using, for example, an integrated circuit that can be programmed by a user, such as an FPGA (field-programmable gate array) or a microcomputer. In such a case, a program formed from each of the above-described components may be implemented by using this integrated circuit. This is also applicable to a settlement process unit according to another exemplary embodiment described below.

The movement-trajectory detection unit 202 receives the movement-trajectory image from the movement-trajectory image-pickup apparatus 20 via the communication device 116. The movement-trajectory detection unit 202 analyzes the movement-trajectory image and thereby identifies each customer who is shot in (i.e., caught on) the movement-trajectory image. Then, the movement-trajectory detection unit 202 generates a customer identifier corresponding to each identified customer. Further, the movement-trajectory detection unit 202 assigns the generated customer identifier to each customer shot in the movement-trajectory image. Moreover, the movement-trajectory detection unit 202 analyzes the movement-trajectory image and thereby detects the movement trajectory indicating how each customer who is assigned the customer identifier has moved within the store 50. Specifically, the movement-trajectory detection unit 202 detects which position each customer has visited in the store 50. More specifically, the movement-trajectory detection unit 202 detects which store shelf each customer has visited in the store 50. Then, the movement-trajectory detection unit 202 generates movement trajectory information, indicating which store shelf the customer has visited, and stores the generated movement trajectory information in the movement-trajectory information storage unit 204.

Note that the phrase “customer visits the store shelf” is a concept including, for example, a case where the customer picks up a commodity displayed on the store shelf. However, the phrase “customer visits the store shelf” does not always mean that the customer picks up a commodity. The phrase “customer visits the store shelf” is also a concept including a general purchasing activity in which the customer gets interested in a commodity displayed on the store shelf and selects the commodity, such as a case where the customer reaches for a commodity displayed on the store shelf and a case where the customer simply looks at a commodity displayed on the store shelf.

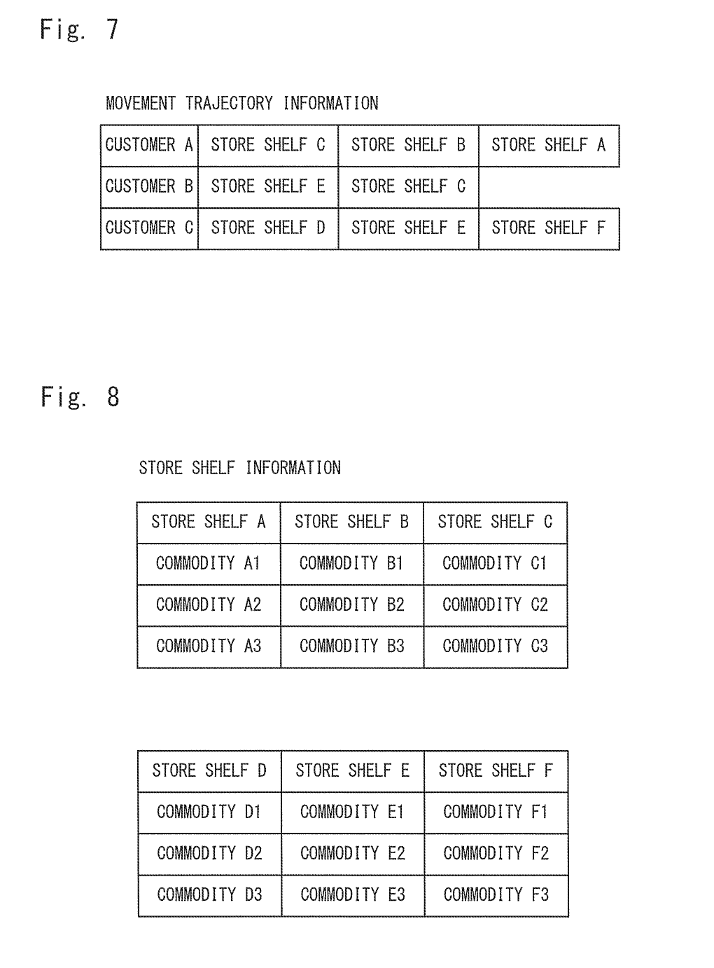

FIG. 7 shows an example of the movement trajectory information stored in the movement-trajectory information storage unit 204. The movement trajectory information includes the customer identifiers and identifiers (store shelf identifier) of the store shelves which have been visited by the customer corresponding to the customer identifier. That is, the customer identifier is associated with the store shelf identifier in the movement trajectory information. FIG. 7 shows an example where the customer A has visited the store shelves C, B and A, the customer B has visited the store shelves E and C, and the customer C has visited the store shelves D, E and F. In FIG. 7, for example, the “customer A” indicates the customer identifier corresponding to the customer A. For example, the “store shelf A” indicates the store shelf identifier corresponding to the store shelf A.

Note that there are various existing methods by which the movement-trajectory detection unit 202 may analyze the movement-trajectory image and thereby identify each customer. For example, the movement-trajectory detection unit 202 may perform a face recognition process for the customer who is shot in the movement-trajectory image and thereby generate a face data corresponding to the customer. Then, the movement-trajectory detection unit 202 may set the generated face data as the customer identifier or may set an identifier generated by using the face data as the customer identifier. For example, the movement-trajectory detection unit 202 may extract information (customer feature information) indicating feature(s) of the customer who is shot in the movement-trajectory image and set the customer feature information as the customer identifier. For example, the movement-trajectory detection unit 202 may analyze colors of clothing of the customer, height of the customer, age and gender of the customer and the like, and set the customer feature information indicating these features as the customer identifier.

Further, there are various existing methods by which the movement-trajectory detection unit 202 may analyze the movement-trajectory image and thereby detect the store shelf which has been visited by each customer. For example, when the customer shot in the movement-trajectory image has stopped in front of a store shelf for a given length of time, the movement-trajectory detection unit 202 may determine that the customer has visited the store shelf. Further, for example, when the movement-trajectory detection unit 202 detects that the customer shot in the movement-trajectory image has approached within a given distance of a store shelf, the movement-trajectory detection unit 202 may determine that the customer has visited the store shelf. Further, when the movement-trajectory detection unit 202 detects that the customer shot in the movement-trajectory image has reached for a store shelf, the movement-trajectory detection unit 202 may determine that the customer has visited the store shelf. Moreover, when the customer shot in the movement-trajectory image has simply passed in front of a store shelf, the movement-trajectory detection unit 202 may determine that the customer has visited the store shelf. This is also applicable to another exemplary embodiment described below.

Further, the movement trajectory information may include a time (time information) at which each customer has visited each store shelf. The movement trajectory information may include a time (time information) at which each customer has gone into the store 50. That is, the movement-trajectory detection unit 202 may detect the movement trajectory of each customer, in such a manner that the movement trajectory is associated with the time at which each customer has visited each store shelf. In the example shown in FIG. 7, the movement trajectory information about the customer A may include time information indicating a time at which the customer A has gone into the store 50, time information indicating a time at which the customer A has visited the store shelf C, time information indicating a time at which the customer A has visited the store shelf B, and time information indicating a time at which the customer A has visited the store shelf A. Note that the time at which each customer has visited each store shelf may mean a time at which the movement-trajectory detection unit 202 has determined that the customer has visited the store shelf.

The settlement-customer identification unit 210 determines that a settlement customer is in front of the POS terminal apparatus 100. The settlement-customer identification unit 210 performs an identification process for the settlement customer. Further, the settlement-customer identification unit 210 generates a settlement customer identifier indicating the settlement customer and outputs the generated settlement customer identifier to the commodity recognition process unit 230. Note that specific methods by which the settlement-customer identification unit 210 determines that a settlement customer is in front of the POS terminal apparatus 100 will be explained in exemplary embodiments described later. Further, the settlement-customer identification unit 210 generates the settlement customer identifier in a way similar to a way that the movement-trajectory detection unit 202 generates the customer identifier. For example, when the movement-trajectory detection unit 202 performs the face recognition process, the settlement customer identifier may indicate the face data or perhaps the identifier generated by using the face data. When the movement-trajectory detection unit 202 extracts the customer feature information, the settlement customer identifier may indicate the customer feature information.

The commodity image acquisition unit 220 controls the commodity image-pickup unit 130 so that the commodity image-pickup unit 130 shoots a commodity pointed toward the commodity image-pickup unit 130. Then the commodity image acquisition unit 220 acquires the settlement commodity image generated by the commodity image-pickup unit 130 and outputs the settlement commodity image to the commodity recognition process unit 230.

The store-shelf information storage unit 232 stores store shelf information indicating a relationship between each store shelf and commodities displayed on the store shelf. The store shelf information includes a store shelf identifier and identifiers of commodities (commodity identifier) displayed on the store shelf corresponding to the store shelf identifier. That is, the store shelf identifier is associated with the commodity identifiers in the store shelf information.

FIG. 8 shows an example of the store shelf information stored in the store-shelf information storage unit 232. FIG. 8 shows an example where commodities A1, A2 and A3 are displayed on the store shelf A. In a similar way, FIG. 8 shows that commodities B1, B2 and B3 are displayed on the store shelf B, commodities C1, C2 and C3 are displayed on the store shelf C, commodities D1, D2 and D3 are displayed on the store shelf D, commodities E1, E2 and E3 are displayed on the store shelf E, and commodities F1, F2 and F3 are displayed on the store shelf F. In FIG. 8, for example, the “store shelf A” indicates the store shelf identifier corresponding to the store shelf A. For example, the “commodity A1” indicates the commodity identifier corresponding to the commodity A1.

The reference commodity information storage unit 234 associates names of respective commodities (commodity A1, commodity B1 and the like) with information about the commodities (reference commodity information) and stores them. This reference commodity information is used for the commodity recognition process by the commodity recognition process unit 230. For example, the reference commodity information may be an image that is used as a reference image of a commodity (reference commodity image). Further, for example, the reference commodity information may be data representing a reference feature(s) of a commodity (commodity feature data). For example, the commodity feature data may include at least one of information indicating the shape of the commodity, information indicating the color of the commodity, information indicating the texture (such as a luster) of the commodity, and information indicating text information and a pattern attached to the package of the commodity.

The commodity recognition process unit 230 performs a process for recognizing the commodity by using the settlement commodity image extracted by the commodity image acquisition unit 220. Specifically, the commodity recognition process unit 230 searches the reference commodity information stored in the reference commodity information storage unit 234 and thereby performs pattern matching between the settlement commodity image and the reference commodity information. The POS terminal apparatus 100 performs a settlement process (or a payment process) and the like of the commodity by using the commodity information obtained by the commodity recognition process performed by the commodity recognition process unit 230. The commodity information may include information for identifying the commodity, such as the name of the commodity, the name of the manufacturer of the commodity, or the price of the commodity.

For example, in a case where the reference commodity information is the reference commodity image, the commodity recognition process unit 230 compares the settlement commodity image with the reference commodity image, stored in the reference commodity information storage unit 234, corresponding to each commodity. Then, when the similarity between them meets a permissible value, the commodity recognition process unit 230 associates the settlement commodity with the name of a commodity corresponding to the reference commodity image. Further, for example, in a case where the reference commodity information is the commodity feature data, the commodity recognition process unit 230 extracts a feature(s) of the image from the settlement commodity image. Then, the commodity recognition process unit 230 compares the extracted feature of the image with the commodity feature data, stored in the reference commodity information storage unit 234, corresponding to each commodity. Then, when the similarity between them meets a permissible value, the commodity recognition process unit 230 associates the settlement commodity with the name of a commodity corresponding to the commodity feature data.

Note that the commodity recognition process unit 230 according to this exemplary embodiment performs the recognition process for the settlement commodity in which commodities displayed on the store shelf which has been visited by the settlement customer are set as candidates. Specifically, for example, the commodity recognition process unit 230 sets commodities, displayed on the store shelf which has been visited by the settlement customer, to be searched in the commodity recognition process. Then, the commodity recognition process unit 230 performs the recognition process for the settlement commodity by retrieving the settlement commodity from among the commodities to be searched. That is, the commodity recognition process unit 230 obtains the reference commodity information corresponding to the commodities displayed on the store shelf which has been visited by the settlement customer from the reference commodity information storage unit 234. Then, the commodity recognition process unit 230 performs the recognition process for the settlement commodity by using the obtained reference commodity information. Details of these processes are described later.

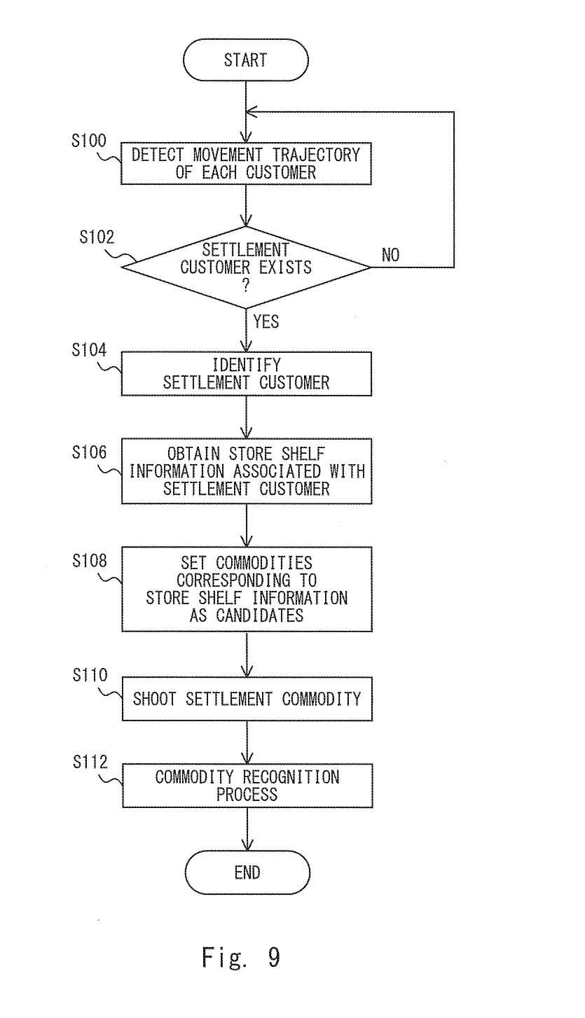

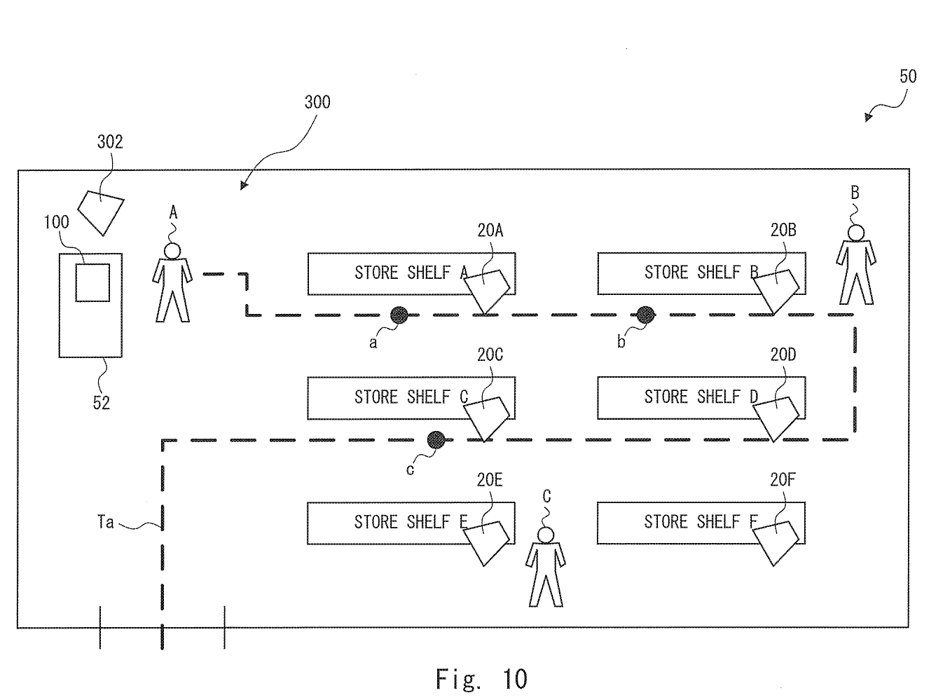

FIG. 9 is a flowchart showing a process performed by the POS terminal apparatus 100 according to the first exemplary embodiment. The POS terminal apparatus 100 detects a movement trajectory of each customer (S100). Specifically, as described above, the movement-trajectory detection unit 202 obtains the movement-trajectory image from the movement-trajectory image-pickup apparatus 20. The movement-trajectory detection unit 202 generates the customer identifier for each customer who is shot in the movement-trajectory image. Further, the movement-trajectory detection unit 202 detects store shelves (positions) which each customer has visited in the store 50. Then, the movement-trajectory detection unit 202 generates the movement trajectory information for each customer and stores the generated movement trajectory information in the movement-trajectory information storage unit 204. The process at S100 can be always performed.

The POS terminal apparatus 100 determines whether a settlement customer is in front of the POS terminal apparatus 100 (S102). Specifically, for example, the settlement-customer identification unit 210 may determine a settlement customer is in front of the POS terminal apparatus 100 by detecting that the settlement customer is shot by an image-pickup apparatus mounted near the POS terminal apparatus 100. Further, for example, the settlement-customer identification unit 210 may determine a settlement customer is in front of the POS terminal apparatus 100 by receiving a movement-trajectory image from the movement-trajectory image-pickup apparatus 20 to analyze the movement-trajectory image.

When it is determined that a settlement customer is not in front of the POS terminal apparatus 100 (NO at S102), the processes of S100 and S102 are repeated. On the other hand, when it is determined that a settlement customer is in front of the POS terminal apparatus 100 (YES at S102), the settlement-customer identification unit 210 identifies the settlement customer (S104). Specifically, as described above, the settlement-customer identification unit 210 identifies the settlement customer by performing the face recognition process or performing the process for extracting customer feature information. Then, the settlement-customer identification unit 210 generates the settlement customer identifier.

The commodity recognition process unit 230 obtains, from the movement-trajectory information storage unit 204, the store shelf information associated with the settlement customer (S106). Specifically, the commodity recognition process unit 230 receives the settlement customer identifier from the settlement-customer identification unit 210. The commodity recognition process unit 230 retrieves the customer identifier corresponding to the received settlement customer identifier from the movement trajectory information stored in the movement-trajectory information storage unit 204. Further, the commodity recognition process unit 230 obtains the store shelf identifier associated with the retrieved customer identifier. Then, the commodity recognition process unit 230 obtains, from the store-shelf information storage unit 232, the store shelf information corresponding to the obtained store shelf identifier.

For example, in a case where the settlement customer identifier indicates the customer A, the commodity recognition process unit 230 obtains the store shelf identifiers corresponding to the store shelves C, B and A, which are associated with the customer A from the movement trajectory information shown in FIG. 7 as an example. Then, the commodity recognition process unit 230 obtains the store shelf information corresponding to each of the store shelves C, B and A from the store-shelf information storage unit 232.

The commodity recognition process unit 230 sets the commodities corresponding to the obtained store shelf information as candidates for the settlement commodity (S108). Specifically, the commodity recognition process unit 230 sets the reference commodity information related to the obtained store shelf information as targets for an image search. In the example described above, because the obtained store shelf information corresponds to the store shelf C, the commodity recognition process unit 230 sets the commodities C1, C2 and C3 associated with the store shelf C to be searched, as shown in FIG. 8 as an example. In a similar way, because the obtained store shelf information corresponds to the store shelf B, the commodity recognition process unit 230 sets the commodities B1, B2 and B3 associated with the store shelf B to be searched. In a similar way, because the obtained store shelf information corresponds to the store shelf A, the commodity recognition process unit 230 sets the commodities A1, A2 and A3 associated with the store shelf A to be searched.

The POS terminal apparatus 100 shoots (i.e., photographs) the settlement commodity (S110). Specifically, the commodity image acquisition unit 220 controls the commodity image-pickup unit 130 so that the commodity image-pickup unit 130 shoots the settlement commodity pointed toward the commodity image-pickup unit 130. Then, the commodity image acquisition unit 220 obtains the settlement commodity image generated by the commodity image-pickup unit 130.

Next, the commodity recognition process unit 230 performs the commodity recognition process by using the reference commodity information on commodities which are set as candidates (are set to be searched) in the process performed at S108 (S112). Specifically, the commodity recognition process unit 230 performs pattern matching between the settlement commodity image and the reference commodity information of the commodities which are set to be searched in the process performed at S108. Then, when the similarity between them meets a permissible value, the commodity recognition process unit 230 determines that the settlement commodity is a commodity corresponding to the reference commodity image. In the example described above, the commodities which are set to be searched are the commodities C1, C2 and C3, the commodities B1, B2 and B3, and the commodities A1, A2 and A3. Therefore, the commodity recognition process unit 230 performs the pattern matching between the settlement commodity image and the reference commodity information of each of the commodities C1, C2 and C3, the commodities B1, B2 and B3, and the commodities A1, A2 and A3. Then, when the similarity between the settlement commodity image and the reference commodity information corresponding to the commodity A1 meets a permissible value, the commodity recognition process unit 230 determines that the settlement commodity is the commodity A1.

The settlement commodity for which a customer is about to make a settlement is usually taken by the settlement customer from commodities displayed on the store shelves. Therefore, in the first exemplary embodiment, the commodity recognition process narrows the range of the search to commodities related to the store shelves which have been visited by the settlement customer.

When the search refinement as is done in the exemplary embodiment is not performed, the commodity recognition process unit 230 needs to perform the commodity recognition process (the pattern matching process) for all information stored in the reference commodity information storage unit 234. When there is a huge quantity of information stored in the reference commodity information storage unit 234, it may take an enormous amount of time to perform the commodity recognition process.

On the other hand, by performing the search refinement as is done in the exemplary embodiment, the POS terminal apparatus 100 needs to perform the commodity recognition process (the pattern matching process) for only the reference commodity information corresponding to commodities related to the store shelves which have been visited by the settlement customer. This reduces the number of commodities to be searched, and thereby it is possible to reduce the amount of time for performing the commodity recognition process. Therefore, the POS terminal apparatus 100 according to the exemplary embodiment can efficiently perform the commodity recognition.

Further, as the exemplary embodiment, by performing the commodity recognition process in which commodities displayed on the store shelf which has been visited by the settlement customer are set as candidates, it is possible to prevent or reduce erroneous recognitions. For example, supposing that the settlement commodity is an apple and the apple is displayed on the store shelf A. Further, suppose that a tomato, whose appearance is similar to that of the apple, is displayed on the store shelf E. Further, suppose that the settlement customer has visited the store shelf A but has not visited the store shelf E. In this case, the POS terminal apparatus 100 according to the exemplary embodiment sets the apple to be searched and does not set the tomato to be searched when the POS terminal apparatus 100 performs the commodity recognition process. Accordingly, the POS terminal apparatus 100 does not erroneously recognize the tomato as the settlement commodity when performing the commodity recognition process. Therefore, the POS terminal apparatus 100 according to the exemplary embodiment can prevent or reduce erroneous recognitions, and thereby efficiently perform the commodity recognition.

### Second Exemplary Embodiment

Next, a second exemplary embodiment is explained. The second exemplary embodiment represents an example, of the first exemplary embodiment, in which the movement-trajectory image-pickup apparatus 20 is provided with respect to each store shelf. Note that configurations substantially similar to the configurations in the first exemplary embodiment are denoted by the same reference numerals as those in the first exemplary embodiment, and thus repeated descriptions thereof are omitted (this is also applicable to another exemplary embodiment described below).

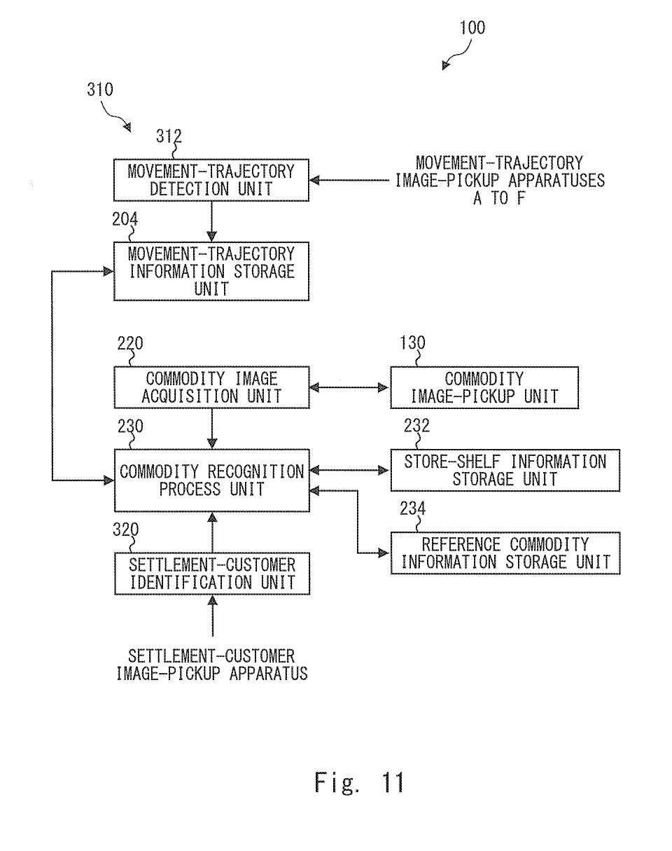

FIG. 10 shows an example of a store 50 to which the POS system 300 according to the second exemplary embodiment is applied. The POS system 300 includes the POS terminal apparatus 100, movement-trajectory image-pickup apparatuses A 20A to F 20F (i.e., a movement-trajectory image-pickup apparatus A 20A, a movement-trajectory image-pickup apparatus B 20B, a movement-trajectory image-pickup apparatus C 20C, a movement-trajectory image-pickup apparatus D 20D, a movement-trajectory image-pickup apparatus E 20E, and a movement-trajectory image-pickup apparatus F 20F), and a settlement-customer image-pickup apparatus 302. The hardware configuration of the POS terminal apparatus 100 according to the second exemplary embodiment is substantially similar to that of the POS terminal apparatus 100 according to the first exemplary embodiment. Further, the movement-trajectory image-pickup apparatuses A 20A to F 20F include a function similar to that of the movement-trajectory image-pickup apparatus 20. That is, the movement-trajectory image-pickup apparatuses A 20A to F 20F are connected to the POS terminal apparatus 100 so that communication can be performed therebetween.

The movement-trajectory image-pickup apparatus A 20A is disposed near the store shelf A and shoots (i.e., photographs) a customer who visits the store shelf A. In a similar way, the movement-trajectory image-pickup apparatus B 20B is disposed near the store shelf B and shoots a customer who visits the store shelf B. The movement-trajectory image-pickup apparatus C 20C is disposed near the store shelf C and shoots a customer who visits the store shelf C. The movement-trajectory image-pickup apparatus D 20D is disposed near the store shelf D and shoots a customer who visits the store shelf D. The movement-trajectory image-pickup apparatus E 20E is disposed near the store shelf E and shoots a customer who visits the store shelf E. The movement-trajectory image-pickup apparatus F 20F is disposed near the store shelf F and shoots a customer who visits the store shelf F.

The settlement-customer image-pickup apparatus 302 is disposed near the POS terminal apparatus 100. Similar to the movement trajectory image pickup apparatus 20, the settlement-customer image-pickup apparatus 302 is connected to the POS terminal apparatus 100 so that communication can be performed therebetween. The settlement-customer image-pickup apparatus 302 is, for example, an image pickup device (camera) such as a CCD and performs a process for reading (i.e., taking) an image (a still image or a moving image) of the settlement customer. Specifically, the settlement-customer image-pickup apparatus 302 shoots (i.e., photographs (hereinafter simply expressed as “shoots”)) the settlement customer and generates a color or monochrome image (settlement customer image) including an image of the settlement customer. The settlement-customer image-pickup apparatus 302 transmits, to the POS terminal apparatus 100, the settlement customer image which is obtained by shooting.

FIG. 11 is a functional block diagram of the POS terminal apparatus 100 according to the second exemplary embodiment. The POS terminal apparatus 100 according to the second exemplary embodiment includes a settlement process unit 310. The settlement process unit 310 includes a movement-trajectory detection unit 312, the movement-trajectory information storage unit 204, a settlement-customer identification unit 320, the commodity image acquisition unit 220, the commodity recognition process unit 230, the store-shelf information storage unit 232, and the reference commodity information storage unit 234.

The movement-trajectory detection unit 312 receives movement-trajectory images taken by the movement-trajectory image-pickup apparatuses A 20A to F 20F from the movement-trajectory image-pickup apparatuses A 20A to F 20F, respectively. The movement-trajectory detection unit 312 analyzes the movement-trajectory image and thereby identifies a customer who has visited each of the store shelves A to F. Then, similar to the movement-trajectory detection unit 202, the movement-trajectory detection unit 312 generates movement trajectory information, indicating which store shelf the customer has visited, and stores the generated movement trajectory information in the movement-trajectory information storage unit 204. Details of processes performed by the movement-trajectory detection unit 312 are described later.

The settlement-customer identification unit 320 receives the settlement customer image taken by the settlement-customer image-pickup apparatus 302. The settlement-customer identification unit 320 analyzes the settlement customer image and thereby determines that a settlement customer is in front of the POS terminal apparatus 100. Further, the settlement-customer identification unit 320 analyzes the settlement customer image and thereby performs the recognition process for the settlement customer. Further, the settlement-customer identification unit 320 generates the settlement customer identifier indicating the settlement customer and outputs the generated settlement customer identifier to the commodity recognition process unit 230. Details of processes performed by the settlement-customer identification unit 320 are described later.

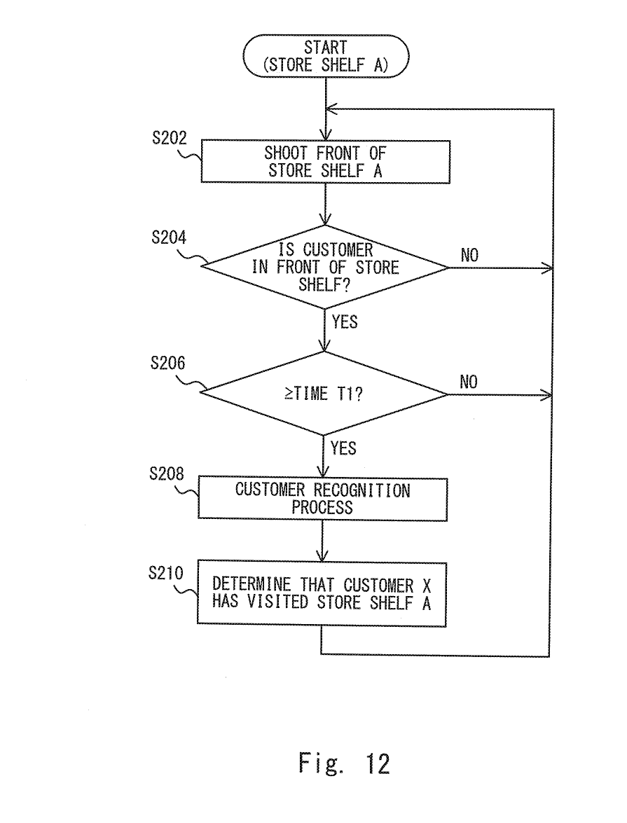

FIG. 12 is a flowchart showing a movement-trajectory detection process according to the second exemplary embodiment. Although FIG. 12 shows a movement-trajectory detection process for the store shelf A, a similar process is performed for each of the store shelves B to F.

The movement-trajectory detection unit 312 obtains, from the movement-trajectory image-pickup apparatus A 20A, the movement-trajectory image obtained by shooting the front of the store shelf A (S202). Specifically, the movement-trajectory image-pickup apparatus A 20A shoots the front of the store shelf A and transmits the obtained movement-trajectory image to the POS terminal apparatus 100. Accordingly, the movement-trajectory detection unit 312 obtains the movement-trajectory image corresponding to the store shelf A from the movement-trajectory image-pickup apparatus A 20A.

The movement-trajectory detection unit 312 determines whether a customer is in front of the store shelf A (S204). Specifically, the movement-trajectory detection unit 312 analyzes the movement-trajectory image corresponding to the store shelf A and thereby determines whether a human image is included in the movement-trajectory image. Although one of the examples of a method for determining whether a human image is included in the movement-trajectory image is, for example, the face recognition process, the method is not limited to the face recognition process. In a case where the face recognition process is used, when the movement-trajectory detection unit 312 determines that an image of a human face is included in the movement-trajectory image, the movement-trajectory detection unit 312 determines that a customer is in front of the store shelf A.

When it is determined that a customer is not in front of the store shelf A (NO at S204), the processes of S202 and S204 are repeated. On the other hand, when it is determined that a customer is in front of the store shelf A (YES at S204), the movement-trajectory detection unit 312 determines whether the customer remains in front of the store shelf A for predetermined time T1 or more (S206). Specifically, the movement-trajectory detection unit 312 analyzes the movement-trajectory image corresponding to the store shelf A and thereby determines that the customer remains in front of the store shelf A for the time T1 or more when the image of the customer (human) continues to be included in the movement-trajectory image(s) taken for the time T1.

When it is determined that the customer does not remain in front of the store shelf A for the time T1 or more (NO at S206), the processes of S202 to S206 are repeated. On the other hand, when it is determined that the customer remains in front of the store shelf A for the time T1 or more (YES at S206), the movement-trajectory detection unit 312 performs a recognition process for the customer who remains in front of the store shelf A (S208). The example of a method for the recognition process is the above-described method. For example, the movement-trajectory detection unit 312 analyzes the movement-trajectory image corresponding to the store shelf A and thereby performs the face recognition process for the customer who is shot in the movement-trajectory image, and generates the face data corresponding to the customer. Then, the movement-trajectory detection unit 312 generates the customer identifier by using the generated face data. Accordingly, the movement-trajectory detection unit 312 determines that a customer X who is shot in the movement-trajectory image has visited the store shelf A (S210).

Further, the movement-trajectory detection unit 312 performs the processes shown in FIG. 12 for the store shelves B to F. Then, in a way similar to that of the first exemplary embodiment, the movement-trajectory detection unit 312 generates the movement trajectory information shown in FIG. 7 as an example, and stores the generated movement trajectory information in the movement-trajectory information storage unit 204.

In FIG. 10, a trajectory Ta in which the customer A has moved is shown as an example. In this example, the customer A has moved to the fronts of the store shelf C, the store shelf D, the store shelf B and the store shelf A in this order, and then moves to the front of the POS terminal apparatus 100 and is about to perform the settlement for a commodity. When the customer A remains at a position c in front of the store shelf C for the time T1 or more, the movement-trajectory detection unit 312 determines that the customer A has visited the store shelf C. Similarly, when the customer A remains at a position b in front of the store shelf B for the time T1 or more, the movement-trajectory detection unit 312 determines that the customer A has visited the store shelf B. Further, when the customer A remains at a position a in front of the store shelf A for the time T1 or more, the movement-trajectory detection unit 312 determines that the customer A has visited the store shelf A. On the other hand, when the customer A only passes in front of the store shelf D and thereby does not remain in front of the store shelf D for the time T1 or more, the movement-trajectory detection unit 312 determines that the customer A has not visited the store shelf D.

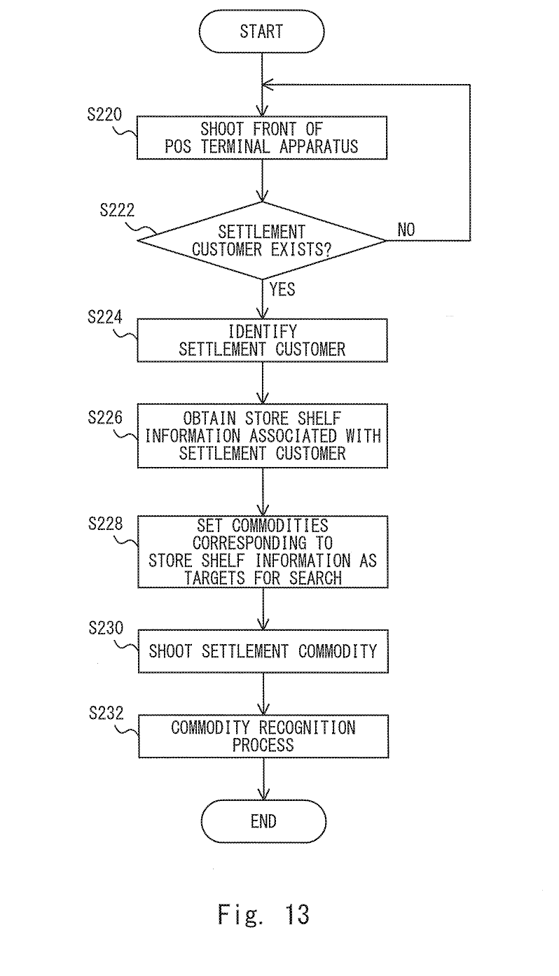

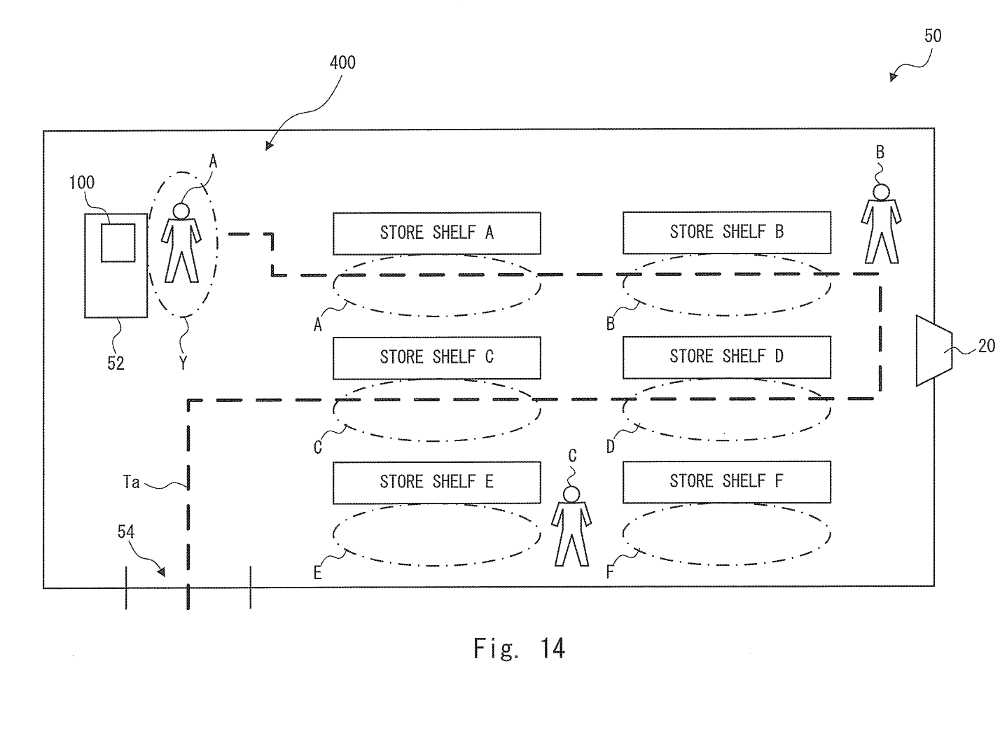

FIG. 13 is a flowchart showing a commodity recognition process according to the second exemplary embodiment.

The settlement-customer identification unit 320 obtains, from the settlement-customer image-pickup apparatus 302, the settlement customer image obtained by shooting the front of the POS terminal apparatus 100 (S220). Specifically, the settlement-customer image-pickup apparatus 302 shoots the front of the POS terminal apparatus 100 and transmits the obtained settlement customer image to the POS terminal apparatus 100. Accordingly, the settlement-customer identification unit 320 obtains the settlement customer image from the settlement-customer image-pickup apparatus 302.

The settlement-customer identification unit 320 determines whether a settlement customer is in front of the POS terminal apparatus 100 (S222). Specifically, the settlement-customer identification unit 320 analyzes a settlement customer image taken by the settlement-customer image-pickup apparatus 302 and thereby determines whether a human image is included in the settlement customer image. Although one of the examples of a method for determining whether a human image is included in the settlement customer image is, for example, the face recognition process, the method is not limited to the face recognition process. In a case where the face recognition process is used, when the settlement-customer identification unit 320 determines that an image of a human face is included in the settlement customer image, the settlement-customer identification unit 320 determines that a settlement customer is in front of the POS terminal apparatus 100.

When it is determined that a settlement customer is not in front of the POS terminal apparatus 100 (NO at S222), the processes of S220 and S222 are repeated. On the other hand, when it is determined that a settlement customer is in front of the POS terminal apparatus 100 (YES at S222), the settlement-customer identification unit 320 identifies the settlement customer (S224). The example of a method for the recognition process is the above-described method. For example, the settlement-customer identification unit 320 performs the face recognition process and generates the face data corresponding to the settlement customer. Then, the settlement-customer identification unit 320 generates the settlement customer identifier by using the generated face data.

In the same way as the process of S106, the commodity recognition process unit 230 obtains, from the movement-trajectory information storage unit 204, store shelf information associated with the settlement customer (S226). Specifically, the commodity recognition process unit 230 receives the settlement customer identifier from the settlement-customer identification unit 320. The commodity recognition process unit 230 retrieves the customer identifier corresponding to the received settlement customer identifier from the movement trajectory information stored in the movement-trajectory information storage unit 204. Further, the commodity recognition process unit 230 obtains the store shelf identifier associated with the retrieved customer identifier. Then, the commodity recognition process unit 230 obtains, from the store-shelf information storage unit 232, the store shelf information corresponding to the obtained store shelf identifier.

In the same way as the process of S108, the commodity recognition process unit 230 sets the reference commodity information related to the obtained store shelf information as targets for an image search (S228). In the same way as the process of S110, the POS terminal apparatus 100 shoots the settlement commodity (S230). Specifically, the commodity image acquisition unit 220 controls the commodity image-pickup unit 130 so that the commodity image-pickup unit 130 shoots the settlement commodity pointed toward the commodity image-pickup unit 130, and thereby obtains the settlement commodity image.

Next, in the same way as the process of S112, the commodity recognition process unit 230 performs the commodity recognition process by using the reference commodity information on commodities which are set to be searched in the process performed at S228 (S232). Specifically, the commodity recognition process unit 230 performs pattern matching between the settlement commodity image and the reference commodity information on the commodities which are set to be searched in the process performed at S228. Then, when the similarity between them meets a permissible value, the commodity recognition process unit 230 determines that the settlement commodity is a commodity corresponding to the reference commodity image.

As described above, by performing the search refinement in the second exemplary embodiment as is done in the first exemplary embodiment, the POS terminal apparatus 100 needs to perform the commodity recognition process (the pattern matching process) for only the reference commodity information corresponding to commodities related to the store shelves which have been visited by the settlement customer. Accordingly, it is possible to reduce the amount of time for performing the commodity recognition process. Therefore, the POS terminal apparatus 100 according to the second exemplary embodiment can efficiently perform the commodity recognition.

Moreover, in the second exemplary embodiment, the image-pickup apparatus, which is provided with respect to each store shelf, shoots a customer who visits the store shelf, and thereby it is possible to detect which store shelf a customer has visited more reliably. Therefore, the POS terminal apparatus 100 according to the second exemplary embodiment can more reliably narrow the range of the search to commodities displayed on the store shelves which have been visited by the settlement customer. Accordingly, it is possible to suppress (i.e., reduce or prevent) an absence of the settlement commodity in targets for searching. Therefore, the POS terminal apparatus 100 according to the second exemplary embodiment can efficiently perform the commodity recognition.

### Third Exemplary Embodiment

Next, a third exemplary embodiment is explained. The third exemplary embodiment represents an example, of the first exemplary embodiment, in which the movement-trajectory image-pickup apparatus 20 is not provided with respect to each store shelf. Although the third exemplary embodiment represents an example in which there is one movement-trajectory image-pickup apparatus 20, the number of movement-trajectory image-pickup apparatuses 20 can be set as appropriate.

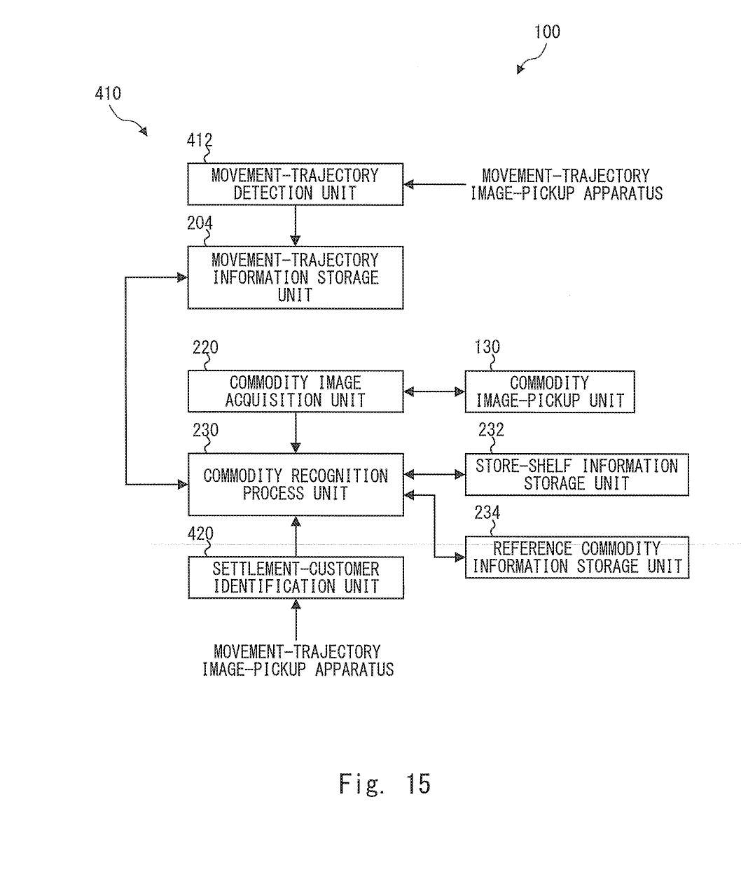

FIG. 14 shows an example of a store 50 to which the POS system 400 according to the third exemplary embodiment is applied. The POS system 400 includes the POS terminal apparatus 100 and the movement-trajectory image-pickup apparatus 20. The hardware configuration of the POS terminal apparatus 100 according to the third exemplary embodiment is substantially similar to that of the POS terminal apparatus 100 according to the first exemplary embodiment. The movement-trajectory image-pickup apparatus 20 is connected to the POS terminal apparatus 100 so that communication can be performed therebetween.

The movement-trajectory image-pickup apparatus 20 shoots (i.e., photographs) each customer moving within the store 50, and obtains a movement-trajectory image. The movement-trajectory image-pickup apparatus 20 is disposed at a position where the movement-trajectory image-pickup apparatus 20 can shoot customer(s) in front of each of the store shelves A to F. That is, the movement-trajectory image-pickup apparatus 20 shoot customer(s) visiting each of the store shelves A to F. Further, the movement-trajectory image-pickup apparatus 20 may include wide-angle lens in order to shoot a broad range inside the store 50.

FIG. 15 is a functional block diagram of the POS terminal apparatus 100 according to the third exemplary embodiment. The POS terminal apparatus 100 according to the third exemplary embodiment includes a settlement process unit 410. The settlement process unit 410 includes a movement-trajectory detection unit 412, the movement-trajectory information storage unit 204, a settlement-customer identification unit 420, the commodity image acquisition unit 220, the commodity recognition process unit 230, the store-shelf information storage unit 232, and the reference commodity information storage unit 234.

The movement-trajectory detection unit 412 receives, from the movement-trajectory image-pickup apparatus 20, the movement-trajectory image taken by the movement-trajectory image-pickup apparatus 20. The movement-trajectory detection unit 412 analyzes the received movement-trajectory image and thereby tracks a movement (movement trajectory) of each of the customers A to C. The movement-trajectory detection unit 412 analyzes the received movement-trajectory image and thereby identifies customer(s) who has visited each of the store shelves A to F by detecting the store shelf which has been visited by the each of the customers A to C. Then, the movement-trajectory detection unit 412 generates the movement trajectory information indicating which store shelf the customer has visited, and stores the generated movement trajectory information in the movement-trajectory information storage unit 204, as is similarly done by the movement-trajectory detection unit 202. Details of processes performed by the movement-trajectory detection unit 412 are described later.

The settlement-customer identification unit 420 receives the movement-trajectory image taken by the movement-trajectory image-pickup apparatus 20. The settlement-customer identification unit 420 analyzes the movement-trajectory image and thereby determines that a customer is in front of the POS terminal apparatus 100 and identifies the customer as the settlement customer. Further, the settlement-customer identification unit 420 generates the settlement customer identifier indicating the settlement customer and outputs the generated settlement customer identifier to the commodity recognition process unit 230. Details of processes performed by the settlement-customer identification unit 420 are described later.

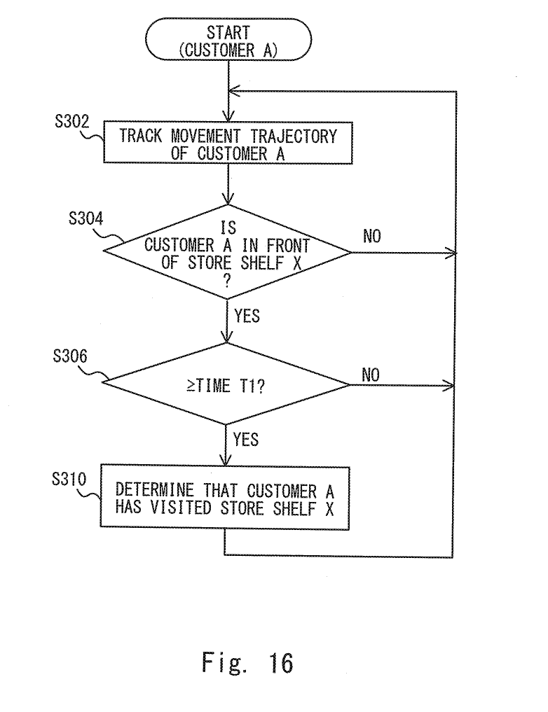

FIG. 16 is a flowchart showing a movement-trajectory detection process according to the third exemplary embodiment. Although FIG. 16 shows a movement-trajectory detection process for the customer A, a similar process is performed for each of the customers B and C.

The movement-trajectory detection unit 412 analyzes the movement-trajectory image generated by the movement-trajectory image-pickup apparatus 20 and thereby tracks a movement trajectory of the customer A (S302). Specifically, the movement-trajectory detection unit 412 detects that a customer moves into the store 50 through an entrance 54 in the movement-trajectory image. A position of an image of the entrance 54 in the movement-trajectory image may be fixed regardless of each time (i.e., at all times). Therefore, the movement-trajectory detection unit 412 analyzes the movement-trajectory image and, when it detects that there is an image of a human at the position corresponding to the entrance 54 in the movement-trajectory image, it identifies the human as “customer A”. Further, the movement-trajectory detection unit 412 generates the customer identifier indicating the “customer A”. In this case, the movement-trajectory detection unit 412 may extract the customer feature information about the customer A and generate the customer identifier by using the customer feature information. Further, when the movement-trajectory detection unit 412 can recognize a face of the customer A in the movement-trajectory image, the movement-trajectory detection unit 412 may generate the customer identifier by using the face data.

Further, the movement-trajectory detection unit 412 tracks (i.e., detects) how the person who has been identified as the “customer A” moves in the store 50. In other words, the movement-trajectory detection unit 412 tracks the movement trajectory of the person identified as the “customer A” in the store 50. An image in the store 50 in the movement-trajectory image can be fixed regardless of each time (i.e., at all times). Thus, for example, the movement-trajectory detection unit 412 tracks (i.e., detects), in the movement-trajectory image, a position to which an image of the person identified as the “customer A” moves in the image of the store 50. Further, the movement-trajectory detection unit 412 may sequentially generate trajectory data indicating the time and the position information of the customer A (coordinate data, etc.) at that time. Accordingly, the movement-trajectory detection unit 412 can generate the trajectory data indicating a movement trajectory Ta (shown in FIG. 14) in which the customer A has moved.

The movement-trajectory detection unit 412 determines whether the customer A is in front of the store shelf X (the store shelves A to F) (S304). Specifically, the movement-trajectory detection unit 412 determines whether the customer A is in a predetermined region X (regions A to F; shown in FIG. 14 by the dashed-dotted line) in front of the store shelf X (the store shelves A to F). More specifically, the movement-trajectory detection unit 412 analyzes the movement-trajectory image and thereby determines whether the image of the person identified as the “customer A” is in the region X in the movement-trajectory image. When the image of the person identified as the “customer A” is in the region X in the movement-trajectory image, the movement-trajectory detection unit 412 determines that the customer A is in front of the store shelf X.

When it is determined that the customer A is not in front of the store shelf X (NO at S304), the processes of S302 and S304 are repeated. On the other hand, when it is determined that the customer A is in front of the store shelf X (YES at S304), the movement-trajectory detection unit 412 determines whether the customer A remains in front of the store shelf X for a predetermined time T1 or more (S306). Specifically, the movement-trajectory detection unit 412 analyzes the movement-trajectory image and thereby determines that the customer A remains in front of the store shelf X for the time T1 or more when the image of the customer A continues to be included in the region X in the movement-trajectory image(s) taken for the time T1.

When it is determined that the customer A does not remain in front of the store shelf X for the time T1 or more (NO at S306), the processes of S302 to S306 are repeated. On the other hand, when it is determined that the customer A remains in front of the store shelf X for the time T1 or more (YES at S306), the movement-trajectory detection unit 412 determines that the customer A has visited the store shelf X (any one of the store shelves A to F) (S310).

Further, the movement-trajectory detection unit 412 performs the processes shown in FIG. 16 for the customers B and C. Then, in a way similar to that of the first exemplary embodiment, the movement-trajectory detection unit 412 generates the movement trajectory information shown in FIG. 7 as an example, and stores the generated movement trajectory information in the movement-trajectory information storage unit 204. The movement trajectory information may include the above-described trajectory data for each of the customers A to C.

In FIG. 14, a trajectory Ta in which the customer A has moved is shown as an example. In this example, the customer A has moved to the fronts of the store shelf C, the store shelf D, the store shelf B and the store shelf A in this order, and then moves to the front of the POS terminal apparatus 100 and is about to perform the settlement for a commodity. In this case, the movement-trajectory detection unit 412 sequentially tracks a trajectory in which the customer A has entered the store through the entrance 54, has moved to the fronts of the store shelf C, the store shelf D, the store shelf B and the store shelf A in this order, and has then moved to the front of the POS terminal apparatus 100.

When the customer A remains in the region C in front of the store shelf C for the time T1 or more, the movement-trajectory detection unit 412 determines that the customer A has visited the store shelf C. Similarly, when the customer A remains in the region B in front of the store shelf B for the time T1 or more, the movement-trajectory detection unit 412 determines that the customer A has visited the store shelf B. Further, when the customer A remains in the region A in front of the store shelf A for the time T1 or more, the movement-trajectory detection unit 412 determines that the customer A has visited the store shelf A. On the other hand, when the customer A only passes in front of the store shelf D and thereby does not remain in the region D in front of the store shelf D for the time T1 or more, the movement-trajectory detection unit 412 determines that the customer A has not visited the store shelf D.

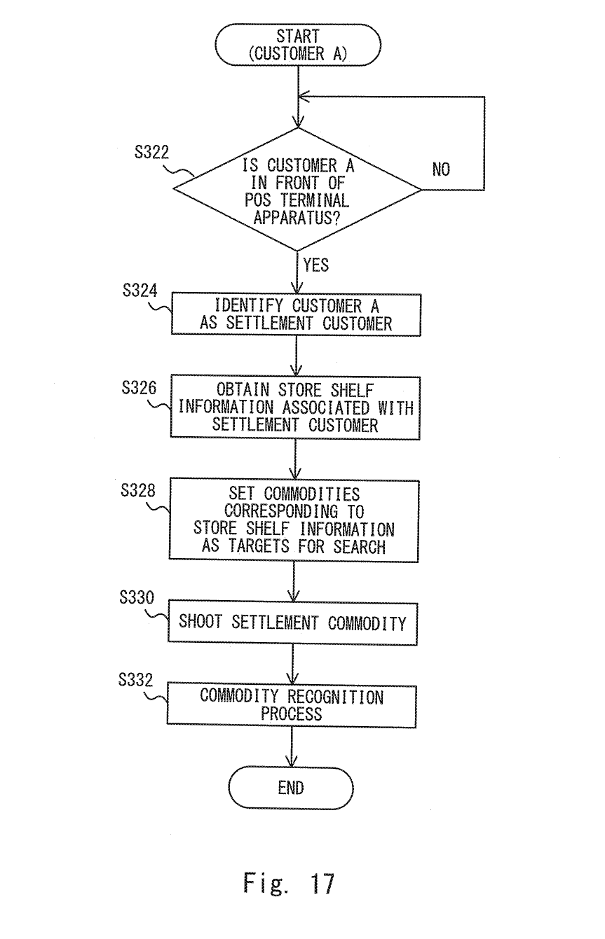

FIG. 17 is a flowchart showing a commodity recognition process according to the third exemplary embodiment. Although FIG. 17 shows a commodity recognition process for the customer A, a similar process is performed for each of the customers B and C.

The settlement-customer identification unit 420 determines whether the customer A is in front of the POS terminal apparatus 100 (S322). Specifically, the settlement-customer identification unit 420 determines whether the customer A is in a predetermined region Y (shown in FIG. 14 by the dashed-dotted line) at the POS terminal apparatus 100. A position of an image of the POS terminal apparatus 100 in the movement-trajectory image may be fixed regardless of each time (i.e., at all times). Therefore, the movement-trajectory detection unit 412 analyzes the movement-trajectory image and thereby determines whether an image of a human identified as “customer A” is in the region Y in the movement-trajectory image. When the image of the human identified as “customer A” is in the region Y in the movement-trajectory image, the movement-trajectory detection unit 412 determines that the customer A is in front of the POS terminal apparatus 100.

When it is determined that the customer A is not in front of the POS terminal apparatus 100 (NO at S322), the process of S320 is repeated. On the other hand, when it is determined that the customer A is in front of the POS terminal apparatus 100 (YES at S322), the settlement-customer identification unit 420 identifies the customer A as the settlement customer (S324).

In the same way as the process of S106, the commodity recognition process unit 230 obtains, from the movement-trajectory information storage unit 204, the store shelf information associated with the settlement customer (customer A) (S326). Specifically, the commodity recognition process unit 230 receives the settlement customer identifier indicating the customer A from the settlement-customer identification unit 420. The commodity recognition process unit 230 retrieves the customer identifier (of the customer A) corresponding to the received settlement customer identifier from the movement trajectory information stored in the movement-trajectory information storage unit 204. Further, the commodity recognition process unit 230 obtains the store shelf identifier associated with the retrieved customer identifier. Then, the commodity recognition process unit 230 obtains, from the store-shelf information storage unit 232, the store shelf information corresponding to the obtained store shelf identifier.

In the same way as the process of S108, the commodity recognition process unit 230 sets the reference commodity information related to the obtained store shelf information as targets for an image search (S328). In the same way as the process of S110, the POS terminal apparatus 100 shoots the settlement commodity (S330). Specifically, the commodity image acquisition unit 220 controls the commodity image-pickup unit 130 so that the commodity image-pickup unit 130 shoots the settlement commodity pointed toward the commodity image-pickup unit 130, and thereby obtains the settlement commodity image.

Next, in the same way as the process of S112, the commodity recognition process unit 230 performs the commodity recognition process by using the reference commodity information on commodities which are set to be searched in the process performed at S328 (S332). Specifically, the commodity recognition process unit 230 performs pattern matching between the settlement commodity image and the reference commodity information on the commodities which are set to be searched in the process performed at S328. Then, when the similarity between them meets a permissible value, the commodity recognition process unit 230 determines that the settlement commodity is a commodity corresponding to the reference commodity image.

As described above, by performing the search refinement in the third exemplary embodiment as is done in the first exemplary embodiment, the POS terminal apparatus 100 needs to perform the commodity recognition process (the pattern matching process) for only the reference commodity information corresponding to commodities related to the store shelves which have been visited by the settlement customer. Accordingly, the amount of the commodities to be searched is reduced, and thereby it is possible to reduce the amount of time for performing the commodity recognition process. Therefore, the POS terminal apparatus 100 according to the third exemplary embodiment can efficiently perform the commodity recognition.

Moreover, in the third exemplary embodiment, it is not necessary to provide the image-pickup apparatus with respect to each store shelf. Therefore, it is possible to reduce the number of the image-pickup apparatuses disposed in the store 50. In particular, the configuration according to the third exemplary embodiment can be applied in a case where the store 50 is relatively small in area and in a case where it is impossible to provide the image-pickup apparatus for each store shelf.

### Modified Example

Note that the present invention is not limited to the aforementioned exemplary embodiments and may be changed as appropriate without departing from the spirit of the present invention. For example, the order of processes in the above-described flowchart can be changed as appropriate. Further, at least one of a plurality of processes in the above-described flowchart may be omitted. For example, the process in S110 in FIG. 9 may be performed after any of the processes in S102 to S108, or may be performed in parallel with the processes in S102 to S108. This is also applicable to FIGS. 13 and 17.

Further, although six store shelves are provided in the above-described exemplary embodiment, any number of store shelves may be provided. Further, although there are three customers in the above-described exemplary embodiment, there may be any number of customers. Similarly, any number of commodities may be displayed on each store shelf.

Further, although the movement-trajectory image-pickup apparatus 20 is provided for each store shelf in the second exemplary embodiment, the present invention is not limited to this configuration. That is, in the second exemplary embodiment, the number of the movement-trajectory image-pickup apparatuses 20 does not need to be identical to the number of the store shelves. The number of the movement-trajectory image-pickup apparatuses 20 may be less than the number of the store shelves, as long as the movement-trajectory detection unit 312 can determine which store shelf the customer has visited. In FIG. 10, for example, the movement-trajectory image-pickup apparatus 20 may be installed between the store shelf A and the store shelf B. Further, although one movement-trajectory image-pickup apparatus 20 is provided in the third exemplary embodiment, the present invention is not limited to this configuration. Two or more movement-trajectory image-pickup apparatuses 20 may be provided.

Further, although, when a customer remains in front of the store shelf A for the time T1 or more, the movement-trajectory detection unit 312 determines that the customer has visited the store shelf A in the second exemplary embodiment, the present invention is not limited to this configuration. For example, when the movement-trajectory detection unit 312 detects that a customer is within a predetermined distance from the store shelf A, the movement-trajectory detection unit 312 may determine that the customer has visited the store shelf A. Further, for example, when the movement-trajectory detection unit 312 detects that a customer reaches for the store shelf A, the movement-trajectory detection unit 312 may determine that the customer has visited the store shelf A. The same applies to the third exemplary embodiment.

Further, the movement-trajectory image-pickup apparatus may take a three-dimensional image. With this configuration, it is possible to accurately detect a position in depth. In this case, the movement-trajectory detection unit may detect which position of the store shelf (e.g., upper stage, lower stage or the like) a customer has reached for. In this case, the store shelf information may indicate the positions of the store shelf on which commodities are displayed, and the commodities displayed there. With this configuration, it is possible to further narrow the range of the commodities to be searched. Accordingly, it is possible to reduce the amount of time for performing the commodity recognition process.

Further, although the customers are independent of each other in the above-described exemplary embodiment, the present invention is not limited to this configuration. That is, each “customer” is not limited to one person and may be a group composed of a plurality of persons. In this case, the movement-trajectory detection unit may recognize a group composed of a plurality of persons and detect the movement trajectory of each member of the group. In this case, when it is detected that there are a plurality of persons at an entrance of the store, the movement-trajectory detection unit may recognize a plurality of the persons as a group. Further, the settlement-customer identification unit may detect that at least one member of the group is about to make a settlement and, in this case, the commodity recognition process unit may extract the store shelf information by using the movement trajectory information about all members of the group.

When a group performs purchasing activity, there is a case where each member individually visits store shelves to pick up commodities and a representative of the group makes a settlement for the commodities at the time of a settlement. In this case, the POS terminal apparatus according to this exemplary embodiment can perform the search refinement with suppressing an absence of the settlement commodity in targets for searching.

In the above-described exemplary embodiment, commodities, displayed on the store shelf which has been visited by the settlement customer, are set to be searched, as a specific example of “performing the recognition process for the settlement commodity in which commodities displayed on the store shelf which has been visited by the settlement customer are set as candidates”. However, the present invention is not limited to this configuration. For example, the above-described concept “commodities displayed on the store shelf which has been visited by the settlement customer are set as candidates” includes not only the search refinement but also the increase in priority of the reference commodity information. Further, this concept includes the commodity recognition process with preferential use of the reference commodity information related to commodities displayed on the store shelf which has been visited by the settlement customer. Accordingly, it is possible to efficiently perform the commodity recognition. In this case, when the settlement commodity cannot be retrieved even with use of the reference commodity information related to commodities displayed on the store shelf which has been visited by the settlement customer, the settlement commodity may be retrieved with use of the reference commodity information related to commodities displayed on the store shelf which has not been visited by the settlement customer.

The movement trajectory detection process according to this exemplary embodiment is not limited to the above-described method, and may be performed by using various existing methods. Further, although the POS terminal apparatus performs the movement trajectory detection process in the above-described exemplary embodiment, the present invention is not limited to this configuration. Another apparatus which can communicate with the POS terminal apparatus may analyze the movement-trajectory image to generate the movement trajectory information, and transmit the generated movement trajectory information to the POS terminal apparatus. That is, the phrase “movement trajectory detection” includes a case where another apparatus performs the analysis process for the movement trajectory and the POS terminal apparatus receives the analysis result (movement trajectory information and the like).

The customer identification process according to this exemplary embodiment is not limited to the above-described method, and may be performed by using various existing methods. Further, although the POS terminal apparatus identifies a customer in the above-described exemplary embodiment, the present invention is not limited to this configuration. Another apparatus which can communicate with the POS terminal apparatus may analyze the movement-trajectory image or the settlement customer image to identify the customer, and transmit the identification result to the POS terminal apparatus. That is, the phrase “identification of customer” includes a case where another apparatus performs the identification process for the customer and the POS terminal apparatus receives the identification result.

Further, when the time information is included in the movement trajectory information, the POS terminal apparatus 100 may set commodities, displayed on the store shelf which has been visited by the settlement customer within a predetermined time before a settlement for a commodity, to be searched in the commodity recognition process. For example, there is a possibility that the customer A may enter the store 50 more than once. In this case, even when the customer A has visited the store shelf E at the previous time of entering the store and the customer A has visited only the store shelf A and has not visited the store shelf E at the present time of entering the store, the POS terminal apparatus 100 may set commodities displayed on the store shelf E to be searched if the POS terminal apparatus 100 uses the movement trajectory information generated at the previous time of the customer A entering the store 50. Therefore, by setting commodities, displayed on the store shelf which has been visited by the settlement customer within a predetermined time before a settlement for a commodity, to be searched in the commodity recognition process, the POS terminal apparatus 100 can set only commodities, displayed on the store shelf A which has been visited by the customer A at this time, to be searched. Thus, the POS terminal apparatus 100 can perform the search refinement more properly, and thereby, it is possible to perform the commodity recognition more efficiently.

The “predetermined time before a settlement” can be set in consideration of the amount of time which a customer ordinarily stays in the store. For example, if the store is a convenience store, commodities, displayed on the store shelf which has been visited by the settlement customer within thirty minutes before a settlement, may be set to be searched in the commodity recognition process. Further, for example, if the store is a mass merchandising store, commodities, displayed on the store shelf which has been visited by the settlement customer within five hours before a settlement, may be set to be searched in the commodity recognition process.

Further, it is possible to combine the components of the second exemplary embodiment and the components of the third exemplary embodiment. For example, an image-pickup apparatus which shoots an entrance of the store 50 may be installed, the image-pickup apparatus may shoot a customer entering the store through the entrance, and thereby the face recognition process may be performed. Then, the movement-trajectory image-pickup apparatus may track a movement trajectory of the customer from the entrance. Further, the settlement-customer image-pickup apparatus which is disposed near the POS terminal apparatus may shoot the customer (settlement customer) and thereby the face recognition process may be performed. The POS terminal apparatus and the POS system according to this exemplary embodiment include these configurations.

Further, although commodities are displayed on store shelves in the above-described exemplary embodiment, the present invention is not limited to this configuration. That is, store shelves are non-essential and it is only necessary to identify on which “position” in the store commodities are displayed, and the commodities displayed there in the store shelf information. In this case, the movement-trajectory detection unit may detect the “position” where the customer has visited. Further, the commodity recognition process unit may perform the commodity recognition process for the settlement commodity, in which commodities displayed at the “position” where the customer the customer has visited are set as candidates. The POS terminal apparatus and the POS system according to this exemplary embodiment include these configurations.

Further, although the configuration according to this exemplary embodiment is applied to a POS terminal apparatus, the entity to which the present invention is applied is not limited to the POS terminal apparatus. For example, the present invention can be applied to general object recognition apparatuses such as those used for sorting out baggage in warehouses or the like, and applied to systems including such an object recognition apparatus.

Further, the POS terminal apparatus 100 according to this exemplary embodiment can be applied to, for example, self-checkout counters. When a customer uses a POS terminal as in the case of the self-checkout counter, the customer is not accustomed to a task of making a reader device read a barcode attached to a commodity. Therefore, in the self-checkout counter, a method in which no barcode is used is desired. That is, a method in which a commodity itself is read (i.e., recognized) is desired. Therefore, by using the POS terminal device 100 according to this exemplary embodiment for the self-checkout counter, problems that could be caused when commodities themselves are read (i.e., recognized) as described above are solved.

Further, this program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

### (Supplementary Notes)

In relation to the above-described exemplary embodiments, the following supplementary notes are also disclosed.

### (Supplementary Note 1)

A commodity recognition method comprising:

detecting movement trajectories of customers in a store by using images taken by at least one image-pickup means;

identifying the customer who is about to make a settlement for a commodity; and

performing a process for recognizing the commodity for the settlement, in which commodities displayed at positions corresponding to the detected movement trajectory for the identified customer are set as candidates.

### (Supplementary Note 2)

The commodity recognition method described in Supplementary note 1, further comprising:

detecting a store shelf that has been visited by the customer; and

performing the process for recognizing the commodity for the settlement, in which commodities displayed on the detected store shelf that has been visited by the identified customer are set as candidates.

### (Supplementary Note 3)

The commodity recognition method described in Supplementary note 2, further comprising performing the process for recognizing the commodity for the settlement, by setting commodities displayed on the detected store shelf that has been visited by the identified customer to be searched and by retrieving the commodity for the settlement from among the commodities to be searched.

### (Supplementary Note 4)

The commodity recognition method described in Supplementary notes 2 or 3, further comprising detecting that the customer has visited the store shelf by shooting of the customer by a plurality of image-pickup means provided with respect to a plurality of the store shelves.

### (Supplementary Note 5)

The commodity recognition method described in any one of Supplementary notes 1 to 4, further comprising:

detecting the movement trajectory, in such a manner that the movement trajectory is associated with the time in which the customer has visited each position corresponding to the movement trajectory; and

performing a process for recognizing the commodity for the settlement, in which commodities displayed at a position that has been visited by the customer within a predetermined time before making a settlement for the commodity are set as candidates.

### (Supplementary Note 6)

A program for causing a computer to execute:

a movement trajectory detection step of detecting movement trajectories of customers in a store by using images taken by at least one image-pickup means;

a customer identification step of identifying the customer who is about to make a settlement for a commodity; and

a recognition process step of performing a process for recognizing the commodity for the settlement, in which commodities displayed at positions corresponding to the detected movement trajectory for the identified customer are set as candidates.

### (Supplementary Note 7)

The program described in Supplementary note 6, wherein

the movement trajectory detection step detects a store shelf that has been visited by the customer; and

the recognition process step performs the process for recognizing the commodity for the settlement, in which commodities displayed on the detected store shelf that has been visited by the identified customer are set as candidates.

### (Supplementary Note 8)

The program described in Supplementary note 7, wherein the recognition process step performs the process for recognizing the commodity for the settlement, by setting commodities displayed on the detected store shelf that has been visited by the identified customer to be searched and by retrieving the commodity for the settlement from among the commodities to be searched.

### (Supplementary Note 9)

The program described in Supplementary notes 7 or 8, wherein the movement trajectory detection step detects that the customer has visited the store shelf by shooting of the customer by a plurality of image-pickup means provided with respect to a plurality of the store shelves.

### (Supplementary Note 10)

The program described in any one of Supplementary notes 6 to 9, wherein

the movement trajectory detection step detects the movement trajectory, in such a manner that the movement trajectory is associated with the time at which the customer has visited each position corresponding to the movement trajectory; and

the recognition process step performs the process for recognizing the commodity for the settlement, in which commodities displayed at a position that has been visited by the customer within a predetermined time before making a settlement for the commodity for the settlement are set as candidates.

Although the present invention is explained above with reference to exemplary embodiments, the present invention is not limited to the above-described exemplary embodiments. Various modifications that can be understood by those skilled in the art can be made to the configuration and details of the present invention within the scope of the invention.

This application is based upon and claims the benefit of priority from Japanese patent applications No. 2014-058107, filed on Mar. 20, 2014, the disclosure of which is incorporated herein in its entirety by reference.

### REFERENCE SIGNS LIST

1 POS TERMINAL APPARATUS
2 MOVEMENT-TRAJECTORY DETECTION UNIT
4 SETTLEMENT-CUSTOMER IDENTIFICATION UNIT
6 COMMODITY RECOGNITION PROCESS UNIT
10 POS SYSTEM
20 MOVEMENT-TRAJECTORY IMAGE-PICKUP APPARATUS
50 STORE
100 POS TERMINAL APPARATUS
110 INFORMATION PROCESSING APPARATUS
112 CONTROL UNIT
114 STORAGE UNIT
116 COMMUNICATION DEVICE
130 COMMODITY IMAGE-PICKUP UNIT
200 SETTLEMENT PROCESS UNIT
202 MOVEMENT-TRAJECTORY DETECTION UNIT
204 MOVEMENT-TRAJECTORY INFORMATION STORAGE UNIT
210 SETTLEMENT-CUSTOMER IDENTIFICATION UNIT
220 COMMODITY IMAGE ACQUISITION UNIT
230 COMMODITY RECOGNITION PROCESS UNIT
232 STORE-SHELF INFORMATION STORAGE UNIT
234 REFERENCE COMMODITY INFORMATION STORAGE UNIT
300 POS SYSTEM
302 SETTLEMENT-CUSTOMER IMAGE-PICKUP APPARATUS
310 SETTLEMENT PROCESS UNIT
312 MOVEMENT-TRAJECTORY DETECTION UNIT
320 SETTLEMENT-CUSTOMER IDENTIFICATION UNIT
400 POS SYSTEM
410 SETTLEMENT PROCESS UNIT
412 MOVEMENT-TRAJECTORY DETECTION UNIT
420 SETTLEMENT-CUSTOMER IDENTIFICATION UNIT

What is claimed is:

1. A POS terminal apparatus comprising:
at least one memory storing instructions, and
at least one processor configured to execute the instructions to:
detect movement trajectories of customers in a store by using images taken by at least one camera;
identify the customer who is about to make a settlement for a commodity; and
perform a process for recognizing the commodity for the settlement, in which commodities displayed at positions corresponding to the detected movement trajectory for the identified customer are set as candidates.

2. The POS terminal apparatus according to claim 1, wherein the at least one processor is further configured to execute the instructions to:
detect a store shelf that has been visited by the customer; and
perform the process for recognizing the commodity for the settlement, in which commodities displayed on the detected store shelf that has been visited by the identified customer are set as candidates.

3. The POS terminal apparatus according to claim 2, wherein the at least one processor is further configured to execute the instructions to perform the process for recognizing the commodity for the settlement, by setting commodities displayed on the detected store shelf that has been visited by the identified customer to be searched and by retrieving the commodity for the settlement from among the commodities to be searched.

4. The POS terminal apparatus according to claim 2, wherein the at least one processor is further configured to execute the instructions to detect that the customer has visited the store shelf by shooting of the customer by a plurality of cameras provided with respect to a plurality of the store shelves.

5. The POS terminal apparatus according to claim 1, wherein the at least one processor is further configured to execute the instructions to:
detect the movement trajectory, in such a manner that the movement trajectory is associated with the time at which the customer has visited each position corresponding to the movement trajectory; and
perform the process for recognizing the commodity for the settlement, in which commodities displayed at a position that has been visited by the customer within a predetermined time before making a settlement for the commodity for the settlement are set as candidates.

6. A POS system comprising:
at least one camera;
at least one memory storing instructions, and
at least one processor configured to execute the instructions to:
detect movement trajectories of customers in a store by using images taken by the at least one camera;
identify the customer who is about to make a settlement for a commodity; and
perform a process for recognizing the commodity for the settlement, in which commodities displayed at positions corresponding to the detected movement trajectory for the identified customer are set as candidates.

7. The POS system according to claim 6, wherein
the camera is provided with respect to each of a plurality of store shelves; and
the camera shoots the customer, and thereby the at least one processor is configured to execute the instructions to detect that the customer has visited the store shelf.

8. A commodity recognition method comprising:
detecting movement trajectories of customers in a store by using images taken by at least one camera;
identifying the customer who is about to make a settlement for a commodity; and
performing a process for recognizing the commodity for the settlement, in which commodities displayed at positions corresponding to the detected movement trajectory for the identified customer are set as candidates.

9. A non-transitory computer readable medium storing a program for causing a computer to execute:
a movement trajectory detection step of detecting movement trajectories of customers in a store by using images taken by at least one camera;
a customer identification step of identifying the customer who is about to make a settlement for a commodity; and
a recognition process step of performing a process for recognizing the commodity for the settlement, in which commodities displayed at positions corresponding to the detected movement trajectory for the identified customer are set as candidates.
